(19) United States
(12) Patent Application Publication
(10) Pub. No.: US 2026/0073213 A1
(43) Pub. Date: Mar. 12, 2026

(54) MODEL DATA PROCESSING SYSTEM AND METHOD, AND STORAGE MEDIUM

(71) Applicant: ALIBABA INNOVATION PRIVATE LIMITED, Singapore (SG)

(72) Inventor: Wente WANG, Hangzhou, Zhejiang (CN)

(21) Appl. No.: 19/100,263

(22) PCT Filed: Dec. 6, 2023
(86) PCT No.: PCT/CN2023/136621

§ 371 Date: Jan. 31, 2025

(30) Foreign Application Priority Data
Dec. 27, 2022 (CN) 202211679737.1

(51) Int. Cl. G06N 3/08

(52) U.S. Cl. CPC G06N 3/08

(57) ABSTRACT

The present application discloses a model data processing system and a method, and a storage medium. The system includes: a first storage device, configured to: determine, based on a predetermined execution order of any execution unit in a deep learning model, a target execution unit to be executed currently; at least one first target storage device, configured to: return and store weight data of the target execution unit stored in a first target storage space, into a first storage space via in turn at least one storage device in a storage device set, where the storage device set includes the at least one first target storage device, and the first target storage device is configured to store in advance, in accordance with the predetermined execution order, weight data of each execution unit into the first target storage space in turn; an execution device, configured to execute the target execution unit based on the weight data of the target execution unit stored in the first storage space. The present application solves the technical problem of large storage space occupied by data processing during model execution.

### CROSS-REFERENCE TO RELATED APPLICATIONS

The present application is a National Stage of International Application No. PCT/CN2023/136621, which claims priority to Application No. 202211679737.1, entitled “MODEL DATA PROCESSING SYSTEM AND METHOD, AND STORAGE MEDIUM” and filed with the China National Intellectual Property Administration on Dec. 27, 2022. These applications are hereby incorporated by reference in their entireties.

### TECHNICAL FIELD

The present application relates to the field of data processing and, in particular, to a model data processing system and a method, and a storage medium.

### BACKGROUND

As scenarios become increasingly complex, more and more deep learning models will be used. In scenarios such as multilingual machine translation, multilingual recognition, or the like, the number of deep learning models for online services can reach over 100.

At present, a general memory of a central processing unit of a single machine and an exclusive memory of a graphics processing unit (GPU) of a single graphics card are limited, and it is impossible to simultaneously deploy all deep learning models on the single machine or the single card. Therefore, in a case of limited resources, there will be a technical problem of large storage space occupied by data processing during the execution of the models.

For the problem mentioned above, there is no effective solution proposed yet.

### SUMMARY

Embodiments of the present application provide a model data processing system and a method, and a storage medium, to at least solve the technical problem of large storage space occupied by data processing during the execution of the models.

According to an aspect of an embodiment of the present application, a model data processing system is provided. The system may include: a first storage device, configured to: determine, based on a predetermined execution order of any execution unit in a deep learning model, a target execution unit to be executed currently, where weight data of the any execution unit is to be loaded into a first storage space of the first storage device; at least one first target storage device, configured to: return and store weight data of the target execution unit stored in a first target storage space, into the first storage space via in turn at least one storage device in a storage device set, where the storage device set includes the at least one first target storage device, and the first target storage device is configured to store in advance, in accordance with the predetermined execution order, weight data of each execution unit into the first target storage space in turn; an execution device, configured to execute the target execution unit based on the weight data of the target execution unit stored in the first storage space.

According to an aspect of an embodiment of the present application, a model data processing method is provided. The method may be applied to a graphics processing unit and may include: determining a deep learning model to be executed; determining, based on a predetermined execution order of any execution unit included in the deep learning model, a target execution unit to be executed currently, where weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit.

According to another aspect of an embodiment of the present application, another model data processing method is provided. The method may include: calling, in response to a model execution instruction acting on an operation interface, a target execution unit to be executed currently, where the target execution unit is determined based on a predetermined execution order of any execution unit included in a deep learning model, and weight data of the any execution unit is loaded into a first storage space of a first storage device; executing the target execution unit, in response to an object execution instruction acting on the operation interface and based on weight data of the target execution unit loaded into the first storage space, where weight data of each execution unit is stored in a first target storage space of at least one first target storage device in a storage device set in accordance with the predetermined execution order of each execution unit, and the weight data of the target execution unit is returned to and stored in the first storage space via in turn at least one storage device included in the storage device set.

According to another aspect of an embodiment of the present application, another model data processing method is provided. The method may include: obtaining, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit to obtain an execution result; outputting the execution result by calling a second interface, where the second interface includes a second parameter, and a parameter value of the second parameter is the execution result.

According to an aspect of an embodiment of the present application, a model data processing apparatus is provided. The apparatus may include: a first determining unit, configured to: determine a deep learning model to be executed; a second determining unit, configured to: determine, based on a predetermined execution order of any execution unit included in the deep learning model, a target execution unit to be executed currently, where weight data of the any execution unit is to be loaded into a first storage space of a first storage device; a first obtaining unit, configured to: obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; a first storage unit, configured to: store the weight data of the target execution unit into the first storage space, where the weight data of the target execution unit stored in the first storage space is used for execution of the target execution unit.

According to another aspect of an embodiment of the present application, another model data processing apparatus is provided. The apparatus may include: a first calling unit, configured to: call, in response to a model execution instruction acting on an operation interface, a target execution unit to be executed currently, where the target execution unit is determined based on a predetermined execution order of any execution unit included in a deep learning model, and weight data of the any execution unit is loaded into a first storage space of a first storage device; an execution unit, configured to: execute the target execution unit, in response to an object execution instruction acting on the operation interface and based on weight data of the target execution unit loaded into the first storage space, where weight data of each execution unit is stored in a first target storage space of at least one first target storage device in a storage device set in accordance with the predetermined execution order of each execution unit, and the weight data of the target execution unit is returned to and stored in the first storage space via in turn at least one storage device included in the storage device set.

According to another aspect of an embodiment of the present application, another model data processing apparatus is provided. The apparatus may include: a second obtaining unit, configured to: obtain, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device; a third obtaining unit, configured to: obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; a second storage unit, configured to: store the weight data of the target execution unit into the first storage space, where the weight data of the target execution unit stored in the first storage space is used for execution of the target execution unit to obtain an execution result; an outputting unit, configured to: output the execution result by calling a second interface, where the second interface includes a second parameter, and a parameter value of the second parameter is the execution result.

According to another aspect of an embodiment of the present application, a computer-readable storage medium is further provided, which includes a program stored thereon, where when the program is running, a device where the storage medium is located is controlled to execute the model data processing method as described in any aspect above.

According to another aspect of an embodiment of the present application, a processor is further provided, which is used to run a program, where when the program is running, the model data processing method as described in any aspect above is executed.

In an embodiment of the present application, a model data processing system is provided. A first storage device determines, based on a predetermined execution order of any execution unit in a deep learning model, a target execution unit to be executed currently, where weight data of the any execution unit is to be loaded into a first storage space of a first storage device; at least one first target storage device returns and stores weight data of the target execution unit stored in a first target storage space, into the first storage space via in turn at least one storage device in a storage device set, where the storage device set includes the at least one first target storage device, and the first target storage device is configured to store in advance, in accordance with the predetermined execution order, weight data of each execution unit into the first target storage space in turn; an execution device executes the target execution unit based on the weight data of the target execution unit stored in the first storage space. That is to say, according to the embodiments of the present application, the storage device set is obtained, and the weight data of each execution unit is stored in the first target storage space in the storage device set in turn. The weight data in the first target storage space can be returned into the first storage space via in turn at least one storage device in the storage device set, thereby finally achieving the purpose of storing the weight data into the first storage device. Before the target execution unit is executed, the weight data corresponding to the target execution unit stored in the first storage space can be obtained, to execute the target execution unit based on the weight data, thereby achieving the technical effect of reducing the storage space occupied by data processing during the execution of the model, and solving the technical problem of large storage space occupied by data processing during the execution of the model.

It is easy to notice that the above general description and the following detailed description are merely to illustrate and explain the present application, and do not constitute a limitation on the present application.

### BRIEF DESCRIPTION OF DRAWINGS

The drawings described herein are used to provide further understanding of the present application and constitute a part of the present application. The illustrative embodiments of the present application and their descriptions are intended to explain the present application and do not constitute improper limitations on the present application. In the drawings:

FIG. 1 is a block diagram of a hardware structure of a computer terminal (or a mobile device) for implementing a model data processing method according to an embodiment of the present application;

FIG. 2 is a structural block diagram of a computing environment according to an embodiment of the present application;

FIG. 3 is a structural block diagram of a service mesh according to an embodiment of the present application;

FIG. 4 is a schematic diagram of a model data processing system according to an embodiment of the present application;

FIG. 5 is a flow chart of a model data processing method according to an embodiment of the present application;

FIG. 6 is a flow chart of another model data processing method according to an embodiment of the present application;

FIG. 7 is a flow chart of another model data processing method according to an embodiment of the present application;

FIG. 8 is a schematic diagram of a computer device accessing a private network according to an embodiment of the present application;

FIG. 9 is a schematic diagram of a connection of minimum execution units of a model according to an embodiment of the present application;

FIG. 10 is a schematic diagram of video memory space occupation according to a related art;

FIG. 11 is a schematic diagram of hierarchical swap-in and swap-out for weight according to an embodiment of the present application;

FIG. 12(a) is a schematic diagram of an execution time according to a related art;

FIG. 12(b) is a schematic diagram of an execution time according to the present application;

FIG. 12(c) is a schematic diagram of an execution time of flexibly determining hierarchical storage according to the present application;

FIG. 13 is a schematic diagram of a model data processing apparatus according to an embodiment of the present application;

FIG. 14 is a schematic diagram of another model data processing apparatus according to an embodiment of the present application;

FIG. 15 is a schematic diagram of another model data processing apparatus according to an embodiment of the present application; and

FIG. 16 is a structural block diagram of a computer terminal according to an embodiment of the present application.

### DESCRIPTION OF EMBODIMENTS

In order to enable those skilled in the art to understand solutions of the present application better, the technical solutions in the embodiments of the present application will be described clearly and completely below in conjunction with the drawings in the embodiments of the present application. Obviously, the described embodiments are part of the embodiments of the present application, rather than all of the embodiments. Based on the embodiments in the present application, all other embodiments obtained by those of ordinary skill in the art without creative work shall belong to the protection scope of the present application.

It should be noted that the terms “first”, “second”, and the like in the specification, claims, and the above-mentioned drawings of the present application are used to distinguish similar objects, and are not necessarily used to describe a specific order or sequence. It should be understood that the terms used in this way are interchangeable under appropriate circumstances such that the embodiments of the present application described herein can be implemented in sequences other than those illustrated or described herein. In addition, the terms “comprising”, “having” and any variants thereof, are intended to cover non-exclusive inclusions. For example, a process, method, system, product, or device that includes a series of steps or elements is not necessarily limited to those steps or elements explicitly listed, but may include other steps or elements not explicitly listed or inherent to such process, method, product, or device.

First, some nouns or terms that appear in the description of the embodiments of the present application are adapted for the following explanations:
a deep learning model, which may be a category of algorithm obtained through data training;
inference, which may refer to a process of a deep learning model running from being given an input to obtaining an output;
inference framework for deep learning, which may refer to a software module that performs inference for a deep learning model;
memory, which may be referred to as internal memory and main memory, may be used to store computational data of a central processing unit, and may refer to the general memory of the central processing unit in the embodiment of the present application;
video memory, which may be referred to as a frame buffer, may be used to store rendering data that has been processed by a display chip or is about to be read, and may specifically refer to the exclusive memory of a GPU in the embodiments as described below;
single card, which may refer to a single graphics card;
execution unit (OP), which may be a minimum execution unit of a model;
tensor, which may be a minimum data storage unit of a model;
deep learning model (Transformer) based on self-attention mechanism, which can be used to assign different weights in accordance with different importance of respective parts of input data during data processing;
convolutional neural network (Convolutional Neural Networks, CNN for short) model, which may be widely used in image recognition;
run time (RT for short), which may refer to the time taken for a model to perform inference once.

### Embodiment 1

According to an embodiment of the present application, a model data processing method is provided. It should be noted that steps shown in a flowchart of drawings can be executed in such as a computer system with a set of computer-executable instructions, and although a logical order is shown in the flowchart, in some cases, the steps shown or described can be executed in an order different from that shown here.

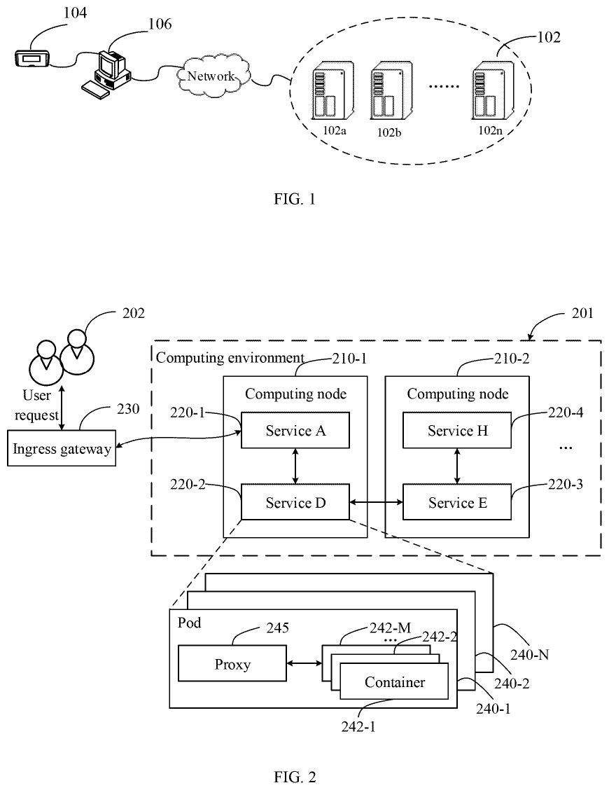

The method embodiment provided in Embodiment 1 of the present application can be executed in a mobile terminal, a computer terminal or a similar computing apparatus. FIG. 1 is a block diagram of a hardware structure of a computer terminal (or a mobile device) for implementing a model data processing method according to an embodiment of the present application. As shown in FIG. 1, a computer terminal A (or a mobile device) may include one or more processors 102 (shown by 102a, 102b, . . . , 102n, which may include but is not limited to a processing apparatus such as a microprocessor unit MPU or a programmable logic device FPGA (Field Programmable Gate Array), etc.), a memory 104 for storing data, and a transmission module 106 for communication functions. In addition, it may further include: a display, an input/output interface (I/O interface), a universal serial bus (USB) port (which may be included as one of the bus ports), a network interface, a power supply and/or a camera. Those of ordinary skill in the art can understand that the structure shown in FIG. 1 is merely illustrative and does not constitute a limitation on the structure of the electronic apparatus described above. For example, the computer terminal A may also include more or fewer components than those shown in FIG. 1, or have a configuration different from that shown in FIG. 1.

It should be noted that one or more processors 102 described above and/or other data processing circuits may generally be referred to herein as “data processing circuit of model”. The data processing circuit of the model may be embodied in whole or in part as software, hardware, firmware or any other combination thereof. In addition, the data processing circuit of the model may be a single independent processing module, or may be fully or partially integrated into any one of the other elements in the computer terminal A (or the mobile device). As involved in the embodiment of the present application, the data processing circuit of the model can be used as a processor control (for example, a selection of a terminal path of a variable resistance connected to an interface).

The memory 104 can be used to store a software program and module of an application software, such as an apparatus for storing program instructions/data, which corresponds to the model data processing method in the embodiment of the present application. The processor 102 executes various functional applications and data processing by running a software program and module stored in the memory 104, that is, realizing the model data processing method as described above. The memory 104 may include a high-speed random access memory, and may also include a non-volatile memory, such as one or more magnetic memory apparatus, flash memory, or other non-volatile solid-state memory. In some examples, the memory 104 may further include a memory that is provided remotely with respect to the processor 102, and these remote memories may be connected to the computer terminal A via a network. Instances of the network include but are not limited to, the Internet, an intranet, a local area network, a mobile communication network, and combinations thereof.

A transmission apparatus 106 is configured to receive or send data via a network. A specific instance of the network above may include a wireless network provided by a communication provider for the computer terminal A. In an instance, the transmission apparatus 106 includes a network interface controller (NIC), which can be connected to other network devices through a base station to communicate with the Internet. In an instance, the transmission apparatus 106 may be a radio frequency (RF) module, which is used to communicate with the Internet wirelessly.

The display may be, for example, a touch-screen liquid crystal display (LCD), which may enable a user to interact with a user interface of the computer terminal A (or the mobile device).

The block diagram of the hardware structure shown in FIG. 1 can serve not only as an illustrative block diagram of the computer terminal A (or the mobile device), but also as an illustrative block diagram of the server. In an implementation, FIG. 2 shows a block diagram of an embodiment in which the computer terminal A (or the mobile device) shown in FIG. 1 is used as a computing node in a computing environment 201. FIG. 2 is a structural block diagram of a computing environment according to an embodiment of the present application. As shown in FIG. 2, the computing environment 201 includes a plurality of computing nodes (e.g., servers, shown in the drawing by 210-1, 210-2, . . . ) running on a distributed network. Each computing node contains local processing and memory resources, and terminal users 202 can remotely run an application or store data in the computing environment 201. The application may be provided as a plurality of services 220-1, 220-2, 220-3, and 220-4 in the computing environment 201, representing services “A”, “D”, “E”, and “H”, respectively.

The terminal user 202 can provide and access services through a web browser or other software applications on a client, and in some embodiments, the provisions and/or requests of the terminal user can be provided to an ingress gateway 230. The ingress gateway 230 can include a corresponding proxy to handle provisions and/or requests for services (one or more services provided in the computing environment 201).

The service is provided or deployed according to various virtualization technologies supported by the computing environment 201. In some embodiments, the service may be provided according to virtual machine (VM for short)-based virtualization, container-based virtualization, and/or similar manners. The virtual machine-based virtualization can be achieved by initializing a virtual machine to simulate a real computer and execute programs and applications without directly contacting any actual hardware resources. While the virtual machine virtualizes a machine, according to the container-based virtualization, the container can be started to virtualize an entire operating system (OS for short) so that a plurality of workloads can run on a single operating system instance.

In an embodiment of the container-based virtualization, several containers of a service can be assembled into a Pod (e.g., a Kubernetes Pod). For example, as shown in FIG. 2, a service 220-2 may be equipped with one or more Pods 240-1, 240-2,. 240-N (collectively referred to as Pod). Each Pod may include a proxy 245 and one or more containers 242-1, 242-2, . . . , 242-M (collectively referred to as container). One or more containers in a Pod handle a request related to one or more corresponding functions of the service, and the proxy 245 typically controls network functions related to the service, such as routing, load balancing, etc. Other services can also be equipped a Pod similar to the Pod.

During operation, executing a user request from the terminal user 202 may require calling one or more services in the computing environment 201, and executing one or more functions of a service may require calling one or more functions of another service. As shown in FIG. 2, service “A” 220-1 receives the user request from the terminal user 202 from the ingress gateway 230, and the service “A” 220-1 may call a service “D” 220-2, and the service “D”220-2 may request a service “E”220-3 to perform one or more functions.

The computing environment described above may be a cloud computing environment, where resource allocation is managed by a cloud service provider, allowing for the development of functionality without a need for considering implementation, adjustment or expansion of servers. The computing environment allows developers to execute codes that are in response to an event without building or maintaining complex infrastructure. Rather than expanding a single hardware device to handle a potential load, the service can be split to perform a set of functions that can scale independently and automatically.

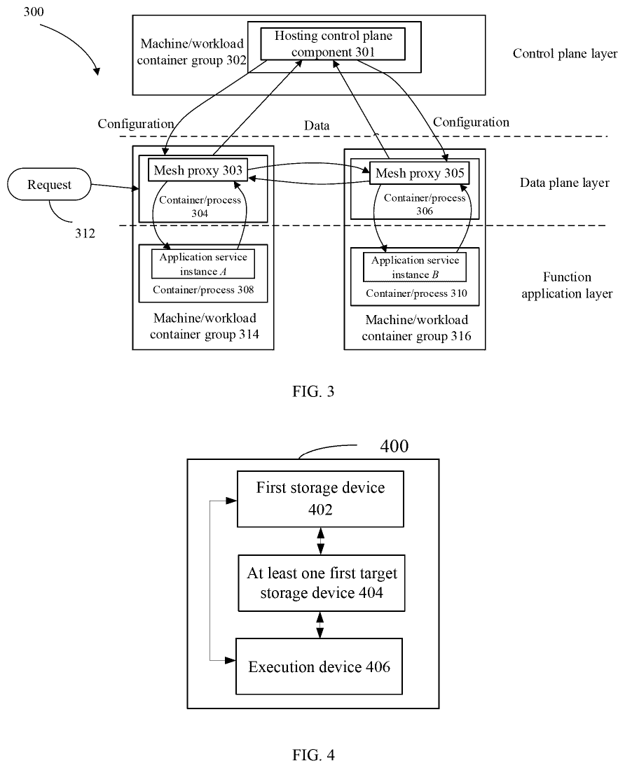

In another embodiment, FIG. 3 shows a block diagram of an embodiment using the computer terminal A (or the mobile device) shown in FIG. 1 as a service mesh. FIG. 3 is a structural block diagram of a service mesh according to an embodiment of the present application. As shown in FIG. 3, the service mesh 300 is mainly used to facilitate secure and reliable communication between a plurality of microservices. The microservice refers to decomposing an application into a plurality of smaller services or instances, and distributing them on different clusters/machines to run.

As shown in FIG. 3, the microservice may include an application service instance A and an application service instance B, and the application service instance A and the application service instance B form a function application layer of the service mesh 300. In an implementation, the application service instance A runs in the form of container/process 308 on a machine/workload container group 314 (Pod), and the application service instance B runs in the form of container/process 310 on a machine/workload container group 316 (Pod).

In an implementation, the application service instance A may be an item query service, and the application service instance B may be an item ordering service.

As shown in FIG. 3, the application service instance A and a mesh proxy (sidecar) 303 coexist in a machine workload container group 314, and the application service instance B and a mesh proxy 305 coexist in a machine workload container group 316. The mesh proxy 303 and the mesh proxy 305 form a data plane layer (dataplane) of service mesh 300. The mesh proxy 303 and the mesh proxy 305 run in the form of container/process 304 and container/process 306 respectively, and can receive a request 312 for the item query service. Also, a bidirectional communication can be performed between the mesh proxy 303 and application service instance A, and a bidirectional communication can be performed between the mesh proxy 305 and the application service instance B. In addition, a bidirectional communication can be also performed between the mesh proxy 303 and the mesh proxy 305.

In an implementation, all traffic of the application service instance A is routed to a suitable destination via the mesh proxy 303, and all network traffic of the application service instance B is routed to a suitable destination via the mesh proxy 305. It should be noted that the network traffic mentioned here includes but is not limited to hyper text transfer protocol (HTTP for short), representational state transfer (REST for short) high performance and other forms.

In an implementation, a functionality for extending the data plane layer can be achieved by writing a custom filter (Filter) for a proxy (Envoy) in the service mesh 300. The proxy configuration of the service mesh can enable the service mesh to correctly act as a proxy for service traffic, to achieve service interoperability and service governance. The mesh proxy 303 and the mesh proxy 305 may be configured to perform at least one of the following functions: service discovery, health checking, routing, load balancing, authentication and authorization, and observability.

As shown in FIG. 3, the service mesh 300 further includes a control plane layer. The control plane layer may be a group of services running in a dedicated namespace, and these services are hosted by a hosting control plane component 301 in the machine/workload container group (machine/Pod) 302. As shown in FIG. 3, the hosting control plane component 301 is in bidirectional communication with the mesh proxy 303 and the mesh proxy 305. The hosting control plane component 301 is configured to perform some functions of control management. For example, the hosting control plane component 301 receives telemetry data transmitted by the mesh proxy 303 and the mesh proxy 305 and can further perform aggregation for the telemetry data. For these services, the hosting control plane component 301 can also provide a user-oriented application programming interface (API for short) to more easily manipulate network behavior, and provide configuration data to the mesh proxy 303 and the mesh proxy 305 and the like.

Under the operating environment mentioned above, the present application provides a model data processing system shown in FIG. 4. FIG. 4 is a schematic diagram of a model data processing system according to an embodiment of the present application. As shown in FIG. 4, the system can include parts as follows.

The system may include a first storage device 402, configured to: determine, based on a predetermined execution order of any execution unit in a deep learning model, a target execution unit to be executed currently, where weight data of the any execution unit is to be loaded into a first storage space of the first storage device.

In this embodiment, the weight data of the any execution unit can be loaded into the first storage space of the first storage device, and the predetermined execution order of the any execution unit can be determined; the target execution unit to be executed currently can be determined based on the predetermined execution order of the any execution unit in the deep learning model, and weight data of the target execution unit can be obtained from the first storage space. The execution unit can be the minimum execution unit (OP) in the deep learning model. The weight data of any execution unit can be loaded into the first storage space, which may be a video memory space, for example, which may be an exclusive memory of a graphics processing unit. This is only an example and there is no specific restriction imposed on the first storage space. The weight data may be a weight tensor (Tensor), which may be used to represent a weight size corresponding to an execution unit.

In an implementation, an inference process of a deep learning model may include a process running from being given an input to obtaining an output. At the beginning of the inference, the weight data relied on by any execution unit contained in the deep learning model needs to be loaded into the first storage space of the first storage device. When the inference is performed, the target execution unit to be executed currently in the execution unit(s) can be determined in accordance with the predetermined execution order.

The system may include at least one first target storage device 404, configured to: return and store the weight data of the target execution unit stored in a first target storage space, into the first storage space via in turn at least one storage device in a storage device set, where the storage device set includes the at least one first target storage device, and the first target storage device is configured to store in advance, in accordance with the predetermined execution order, weight data of each execution unit into the first target storage space in turn.

In this embodiment, the storage device set includes the at least one first target storage device 404, which can store in advance, in accordance with the predetermined execution order, the weight data of each execution unit into the first target storage space of the first target storage device in turn, and can return and store the weight data of the target execution unit stored in the first target storage space, into the first storage space of the first storage device via in turn the at least one storage device in the storage device set. The storage device set may include the first storage device and the at least one first target storage device. The storage space of the at least one first target storage device may have a storage performance lower than the storage performance of the first storage space. For example, it may be a disk space or a memory space that has a storage performance lower than that of a video memory space, or the like. This is only an example and there is no specific restriction imposed on a type of the at least one first target storage device. The first target storage space may be a disk space, and the disk space may be a memory space with low performance and low cost.

In this embodiment, the storage device set can be divided into storage devices with a plurality of levels from low to high, to obtain the at least one first target storage device. The storage space of a storage device with a lower level is closer to the video memory space, and the lower the level, the higher the performance and the higher the unit fee (cost). The first storage space of the first storage device may be a video memory space with a low level. The first target storage space of the at least one first target storage device may be a storage space with a high level, for example, a memory space level1, a disk space level2, and the like.

It should be noted that the number of the at least one first target storage device can be selected according to actual situations, and it may be one or two. There is no specific restriction on the number of the at least one first target storage device included in the storage device set and the number of the first target storage space of the at least one first target storage device.

In an implementation, the number of the first target storage device may be the same as the number of execution units. For example, when there are two execution units, two first target storage devices may be determined from the storage device set.

In this embodiment, the at least one first target storage device can be determined from the storage device set, and the weight data of each execution unit can be stored, in accordance with the predetermined execution order of each execution unit in the deep learning model, into the first target storage space in the first target storage device in turn.

In an implementation, when the inference of the deep learning model starts, the weight data on which each execution unit relies can be stored, in accordance with the predetermined execution order of each execution unit in the deep learning model, into the first target storage space in turn as storage data (cold storage) in the first target storage space.

For example, in an offline state, the weight data of each execution unit can be together loaded, through matching tools in accordance with the predetermined execution order of each execution unit in the deep learning model, into the first target storage space (with high level) as cold storage. Or, in an online state, when the deep learning model starts the first inference, the weight data of each execution unit can be together loaded, in accordance with the predetermined execution order of each execution unit in the deep learning model, into the first target storage space to achieve the purpose of cold storage. It should be noted that the storage manner mentioned above is merely intended for illustration and no specific restrictions are imposed on the storage manner of the weight data herein.

In this embodiment, before the execution unit is executed, the weight data of the target execution unit stored in the first target storage space can be returned into the first storage space via in turn the first target storage device of the at least one first target storage device included in the storage device set.

In an implementation, before each execution unit is executed, the weight data of the to-be-executed target execution unit can be returned to and stored in the first storage space from the first target storage space via in turn the first target storage space of the at least one first target storage device included in the storage device set, thereby copying the weight data from the storage space with high level to the storage space with low level, achieving the purpose of copying the weight data to the first storage space (video memory space).

For example, it is assumed that the first target storage space of the at least one first target storage device includes a disk space Level2 and a memory space Level1, and the execution units include OP0, OP1, and OP2. When OP1 is the target execution unit, weight data corresponding to OP1 stored in the disk space Level2 can be copied from the disk space Level2 to the memory space Level1, and then copied from the memory space Levell to a video memory space Level0; when OP2 is the target execution unit, weight data corresponding to OP2 stored in the disk space Level2 can be copied from the disk space Level2 to the memory space Level1, and then copied from the memory space Levell to the video memory space Level0.

The system may include an execution device 406, configured to execute the target execution unit based on the weight data of the target execution unit stored in the first storage space.

In this embodiment, the target execution unit can be executed by the execution device 406 in accordance with the predetermined execution order and based on the weight data of the target execution unit stored in the first storage space.

For example, when the deep learning model performs inference, the target execution unit can be determined based on the predetermined execution order, and the target execution unit can be executed by the execution device based on the weight data corresponding to the target execution unit stored in the first storage space.

With the system of the present application, the first storage device determines, based on the predetermined execution order of any execution unit in the deep learning model, the target execution unit to be executed currently, where the weight data of the any execution unit is to be loaded into the first storage space of the first storage device; the at least one first target storage device returns and stores the weight data of the target execution unit stored in the first target storage space, into the first storage space via in turn the at least one storage device of the storage device set, where the storage device set includes the at least one first target storage device, and the first target storage device is configured to store in advance, in accordance with the predetermined execution order, the weight data of each execution unit into the first target storage space in turn; the execution device executes the target execution unit based on the weight data of the target execution unit stored in the first storage space. That is to say, according to the embodiments of the present application, the storage device set is obtained, and the weight data of each execution unit is stored in the first target storage space in the storage device set in turn. The weight data in the first target storage space can be returned into the first storage space via in turn at least one storage device in the storage device set, thereby finally achieving the purpose of storing the weight data into the first storage device. Before the target execution unit is executed, the weight data corresponding to the target execution unit stored in the first storage space can be obtained, to execute the target execution unit based on the weight data, thereby achieving the technical effect of reducing the storage space occupied by data processing during the execution of the model, and solving the technical problem of large storage space occupied by data processing during the execution of the model.

The system mentioned above of this embodiment is further introduced below.

In an implementation of a model data processing system, each of the storage devices included in the storage device set has storage performance lower than the storage performance of the first storage device, and/or the first storage space is smaller than storage spaces of the storage devices included in the storage device set.

A space of video memory (which may be an exclusive memory) of a graphics processing unit is usually less than 20 G, the cost is extremely high; while the cost of a space of memory is very low and is less than 1/100 of the cost of the space of the video memory space in a case of having the same storage space. Thus, in this embodiment, the storage performance of each of the storage devices included in the storage device set is lower than the storage performance of the first storage device; the first storage space (video memory space) is smaller than the storage spaces of the storage devices included in the storage device set.

In an implementation of a model data processing system, the storage device set includes a second target storage device in addition to the first target storage device, and storage performance of the second target storage device is higher than storage performance of the first target storage device and lower than storage performance of the first storage device, where the first target storage device is configured to return and store the weight data of the target execution unit retrieved from the first target storage space, into the first storage space via the second target storage device.

In this embodiment, the storage device set can include the first target storage device and the second target storage device other than the first target storage device, where the second target storage device may be a storage device having a storage performance lower than that of the first storage device but higher than that of the first target storage device, and it may be a general memory of a central processing unit, for example, may be a storage device whose storage space is a memory space, and the like. The weight data of the target execution unit can be retrieved from the first target storage device. The extracted weight data can be copied into the second target storage device, and then the weight data stored in the second target storage device can be returned to and stored in the first storage space.

In this embodiment, the storage device set can be divided into a plurality of levels from low to high. The lower the level, the higher the performance and the higher the unit fee (cost). The level of the second target storage device may be lower than that of the first target storage device but higher than that of the first storage device. Therefore, the storage performance of the second target storage device is higher than that of the first target storage device and lower than the storage performance of the first storage device.

In an implementation, the amount of storage space in the storage device set may be determined based on a trade-off between performance and cost in an actual scenario.

In an implementation of a model data processing system, the first target storage device is configured to return and store the weight data of the target execution unit retrieved from the first target storage space, into the first storage space via in turn a plurality of sorted second target storage devices, where the plurality of second target storage devices are sorted in ascending order of storage performance.

In this embodiment, the plurality of second target storage devices can be sorted, in accordance with their storage performance, in ascending order of storage performance, and the weight data of the target execution unit retrieved from the first target storage device can be returned to and stored in the first storage space via in turn the sorted plurality of the second target storage devices.

In an implementation, the storage device set can be divided into the plurality of second target storage devices. In response to a first sorting instruction on an operation interface, the plurality of second target storage devices can be sorted from weak to strong in accordance with their storage performance. The higher the storage performance, the lower the corresponding level. The weight data of the target execution unit retrieved by the first target storage device may be returned to and stored in the first storage space via in turn the sorted plurality of second target storage devices.

For example, the storage device set can be divided into three second target storage devices. In response to the first sorting instruction on the operation interface, the three second target storage devices can be sorted from weak to strong in accordance with the storage performance of the three second target storage devices. The sorted second target storage devices may be named OP4, OP3, and OP2 respectively, where the suffixal numbers can be used to represent the levels corresponding to the second target storage devices. Since the storage performance of the second target storage device is higher than that of the first target storage device, but lower than that of the first storage device, it may be assumed that the first storage device is OP0 and the first target storage device is OP5. The weight data of the target execution unit can be retrieved from OP5, and the obtained weight data can be returned to and stored in OP4. OP4 can return and store the stored weight data into OP3 again. OP3 can return and store the stored weight data into OP2 again. Finally, OP2 can return and store the stored weight data into the first storage space of the first storage device. It should be noted that for the above-mentioned returning and storing, the returning and storing of data can be completed by calling, copying, and other manners, and there is no specific restriction imposed on the manner of returning and storing data.

In a related art, when target execution data is executed, the weight data of all execution data needs to be returned to and stored in the first storage space. In the scheme, the occupancy of the weight data in the video memory space is the sum of the video memory space occupied by all weight data, resulting in a large storage space occupied by data processing during model execution; whereas, in the embodiment of the present application, hierarchy is performed on the storage space of the storage device set to obtain the first storage device, the at least one first target storage device, and the plurality of second target storage devices; the weight data of each execution unit is stored into the first target storage space of the at least one first target storage device; before the target execution unit is executed, the weight data of the target execution unit in the first target storage space can be returned to and stored in the first storage space via in turn the plurality of second target storage devices included in the storage device set, so that the occupation of the video memory space in the model execution process is the largest weight data among all the weight data of the target execution data, and therefore the memory space occupied by the weight data is greatly reduced, thereby achieving the technical effect of reducing the storage space occupied by data processing in the model execution process and solving the problem of large storage space occupied by data processing in the model execution process.

In an implementation of a model data processing system, the at least one first target storage device is configured to copy the weight data of the target execution unit to the first storage device via in turn at least one storage device included in the storage device set.

In this embodiment, the weight data of the target execution unit stored in the at least one first target storage device can be copied to the first storage device via in turn the at least one storage device included in the storage device set.

In an implementation, the system may also include: a processor, configured to: select at least one target identification from identifications of a plurality of storage devices associated with the first storage device, and make storage device(s) corresponding to the at least one target identification form the storage device set, where storage performance of the plurality of storage devices is lower than the storage performance of the first storage device.

In this embodiment, a storage device acquisition instruction on an operation interface can be obtained. The processor can display, in response to the obtained storage device acquisition instruction, the identifications of the plurality of storage devices associated with the first storage device on the operation interface. The at least one target identification can be selected from the identifications of the plurality of storage devices, and the storage device corresponding to the selected at least one target identification can be made to form the storage device set. The identification of the storage device can be used to represent a level of a storage space, for example, it may be level 1, level 2, level 3, and the like, which is merely intended for illustration and there is no specific limitation imposed on the display form of the identification. The storage performance of the plurality of storage devices is lower than the storage performance of the first storage device.

In an implementation, the identification of the storage device on the operation interface can be selected by users based on actual needs. In response to a storage device selection instruction acting on the operation interface, the at least one target identification can be selected from the identifications of the plurality of storage devices on the operation interface, and the storage devices corresponding to the at least one target identifier can be made to form the storage device set.

For example, the identifications of the plurality of storage devices associated with the first storage device may be displayed on the operation interface, which are level 1, level 2, and level 3, respectively, where the higher the level, the lower the performance and the corresponding cost. The user can make trade-offs between performance and cost according to the actual application scenarios for the deep learning model, to select a required storage device in the operation interface. The at least one target identification can be selected from the identifications of the plurality of storage devices on the operation interface, and the storage device corresponding to the at least one target identification can be made to form the storage device set.

In this embodiment, the trade-offs between the performance and the cost of the deep learning model can be performed based on the actual application scenario of the deep learning model, to select a suitable storage device for data storage, thereby further improving the flexibility and practicality of the present application.

In an implementation of a model data processing system, the first storage device is configured to: sort a plurality of execution units in accordance with the predetermined execution order, and determine, among the sorted plurality of execution units, an execution unit which ranks first, as the target execution unit.

In this embodiment, the plurality of execution units included in the deep learning model can be sorted in accordance with the predetermined execution order, and among the sorted plurality of execution units, the execution unit which ranks first can be determined as the target execution unit.

In an implementation of a model data processing system, the first storage device is configured to: determine, among the sorted plurality of execution units after the execution device executes the target execution unit based on the weight data of the target execution unit stored in the first storage space, an execution unit next to the target execution unit as the target execution unit to be executed currently, so that the first target storage device performs the step of returning and storing the weight data of the target execution unit stored in the first target storage space, into the first storage space via in turn the at least one storage device in the storage device set.

In this embodiment, the plurality of execution units can be sorted in accordance with the predetermined execution order. Among the sorted plurality of execution units, the execution unit next to the target execution unit can be determined as the target execution unit to be executed currently, and the weight data of the target execution unit stored in the first target storage device can be returned to and stored in the first storage space via in turn the at least one storage device included in the storage device set.

For example, it is assumed that the predetermined execution order is OP1, OP3, and OP2, and the execution units are sorted based on the predetermined execution order. Among the sorted OP1, OP3, and OP2, the execution unit OP1 which ranks first can be determined as the target execution unit, and the execution unit OP3 next to OP1 can be determined as the target execution unit to be executed currently. When the target execution unit is OP1, the weight data of OP1 stored in the first target storage device can be returned to and stored in the first storage space via in turn the at least one storage device included in the storage device set. When the execution of OP1 is completed, the target execution unit becomes OP3, and the weight data of OP3 stored in the first target storage device can be returned to and stored in the first storage space via in turn the at least one storage device included in the storage device set. In a similar fashion, each execution unit is executed in sequence in accordance with the predetermined execution order.

In an implementation of a model data processing system, the deep learning model includes an execution unit set, where the first target storage device is configured to: select weight data of a plurality of execution units from weight data of the execution unit set, and store weight data of each execution unit into the first target storage space in turn in accordance with the predetermined execution order of each selected execution unit in the deep learning model.

In this embodiment, the user can customize, according to actual needs, an execution unit in the execution unit set for which weight data needs to be obtained, can select the weight data of the plurality of execution units from the weight data of the execution unit set, and can store the weight data of each execution unit into the first target storage space in turn in accordance with the predetermined execution order of each selected execution unit in the deep learning model.

For example, the user can customize, according to actual needs, the execution units in the execution unit set for which weight data needs to be obtained, and in response to a data selection instruction input by the user on the operation interface, only the weight data of the plurality of execution units corresponding to the data selection instruction are selected from the weight data of the execution unit set, and the weight data of the execution units can be stored into the first target storage space in turn in accordance with the predetermined execution order of each selected execution unit in the deep learning model.

Since the process of returning and storing the weight data from the first target storage device to the first storage device may incur a certain amount of time loss, in order to reduce the time loss and improve the data processing efficiency of the deep learning model, the embodiment of the present application further proposes a user-customization strategy. That is, the user can decide, according to actual usage, the weight data that needs to be swapped in and out in a hierarchical manner, and based on a copy strategy set by the user, only the weight data that needs to be copied is handled, thereby achieving the purpose of optimizing the data processing speed of the deep learning model.

For example, the data selection instruction may be for performing swapping in and out on only the top N (TopN) largest weight data in the model. In response to the data selection instruction acting on the operation interface, the TopN largest weight data is selected from the weight data of the execution unit set, and the execution units corresponding to the TopN largest weight data is determined. The weight data of each execution unit can be stored in the first target storage space in turn in accordance with the predetermined execution order of each selected execution unit in the deep learning model.

In an implementation of a model data processing system, the first storage device is configured to: release a storage space occupied by an executed target execution unit in the first storage device, and/or mark the storage space occupied by the executed target execution unit in the first storage device with an invalid state.

In this embodiment, after the execution of the target execution unit is completed, the storage space occupied by the executed target execution unit in the first storage device can be released, and/or the storage space occupied by the executed target execution unit in the first storage device can be marked with the invalid state.

For example, after the execution of each target execution unit is completed, the video memory space occupied by the weight data corresponding to the target execution unit can be released, or the video memory space occupied by the weight data corresponding to the target execution unit can be marked as invalid.

In the embodiment of the present application, hierarchy is performed for storage devices, to obtain the first storage device, the at least one first target storage device and the plurality of second target storage devices; the weight data of each execution unit can be stored in the first target storage space of the at least one first target storage device; and before the target execution unit is executed, the weight data of the target execution unit in the first target storage device can be returned to and stored in the first storage device via in turn the plurality of second target storage devices, thereby achieving the technical effect of reducing the storage space occupied by data processing during the execution of the model and solving the technical problem of the large amount of storage space occupied by data processing during the execution of the model.

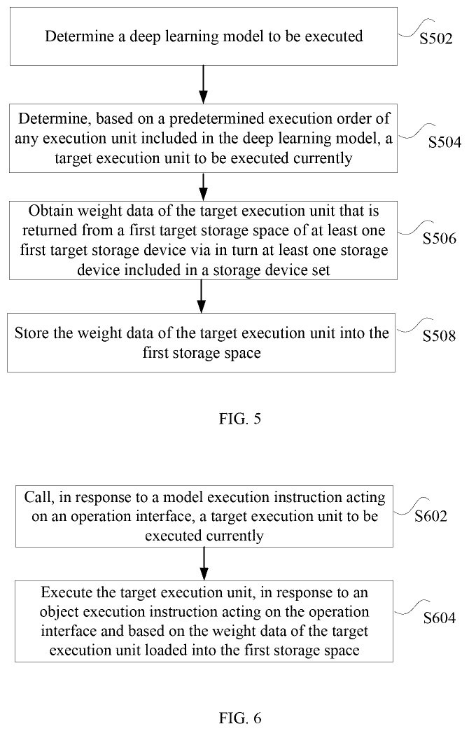

An embodiment of the present application further provides a model data processing method, which can be applied to a graphics processing unit. FIG. 5 is a flow chart of a model data processing method according to an embodiment of the present application. As shown in FIG. 5, the method may include the following steps.

Step S502, determine a deep learning model to be executed.

In the technical solution provided in above-mentioned step S502 of the present application, the deep learning model to be executed under a target scenario can be obtained, where the target scenario may be a multilingual machine translation scenario, a multi-speech recognition scenario, or the like, and there is no specific restriction imposed on the target scenario here.

For example, in scenarios such as multilingual machine translation or multilingual recognition, the number of deep learning models served online can reach more than 100, and the deep learning model to be executed under this target scenario can be obtained.

Step S504, determine, based on a predetermined execution order of any execution unit included in the deep learning model, a target execution unit to be executed currently, where weight data of the any execution unit is to be loaded into a first storage space of a first storage device.

In the technical solution provided in above-mentioned step S504 of the present application, the target execution unit to be executed currently can be determined based on the predetermined execution order of any execution unit included in the deep learning model. The execution unit may be a smallest execution unit (OP) in the deep learning model. The weight data of any execution unit can be loaded into the first storage space. The first storage space may be a video memory space, for example, an exclusive memory of a graphics processing unit, which is merely an illustration and there is no specific limitation imposed on the first storage space here. The weight data may be a weight tensor (Tensor), which may be used to represent a weight size corresponding to an execution unit.

In an implementation, an inference process of a deep learning model may include a process running from being given an input to obtaining an output. At the beginning of the inference, the weight data on which any execution unit contained in the deep learning model relies needs to be loaded into the first storage space of the first storage device. When the inference is performed, the target execution unit to be executed currently in the execution units can be determined in accordance with the predetermined execution order.

Step S506, obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order.

Step S508, store the weight data of the target execution unit into the first storage space, where the weight data of the target execution unit stored in the first storage space is used for execution of the target execution unit.

In the technical solution provided in the above-mentioned step S508 of the present application, the weight data of the target execution unit that returns from the first target storage space of the at least one first target storage device via in turn the at least one storage device included in the storage device set can be obtained. The weight data of the target execution unit is stored into the first storage space, and the target execution unit can be executed based on the weight data of the target execution unit stored in the first storage space.

In scenarios such as multilingual machine translation or multilingual recognition, the limitation of the video memory space results in that only a few deep learning models can perform inference simultaneously during actual processing, which is far less than the total number of models; the number of translation requests that can be processed simultaneously is positively correlated with the number of deep learning models which can perform inference simultaneously; the utilization rate of the computing resources of the central processing unit or graphics processing unit is positively correlated with the number of translation requests per unit time within a certain range. Therefore, in the related art, the limitation of the video memory may lead to the limitation of the number of models that can perform inference, which may result in the insufficient number of translation requests, so that the computing resources of the central processing unit or graphics processing unit cannot be fully utilized and waste is caused. However, in the embodiment of the present application, a deep learning model to be executed is determined; a target execution unit to be executed currently is determined, based on a predetermined execution order of any execution unit included in the deep learning model, where weight data of the any execution unit is to be loaded into a first storage space of a first storage device; the weight data of the target execution unit that is returned from the first target storage space of at least one first target storage device via in turn the at least one storage device included in the storage device set is obtained, where the storage device set includes the at least one first target storage device, and the first target storage device is configured to in advance store the weight data of each execution unit into the first target storage space in turn in accordance with the predetermined execution order; the weight data of the target execution unit is stored in the first storage space, where the weight data of the target execution unit stored in the first storage space is used for execution of the target execution unit, thereby achieving the technical effect of reducing the storage space occupied by data processing during the execution of the model and solving the technical problem of the large amount of storage space occupied by data processing during the execution of the model.

An embodiment of the present application further provides another model data processing method, which can be applied in human-machine interaction scenarios. It should be noted that the model data processing method of this embodiment can be executed by the model data processing system of the embodiment of the present application.

FIG. 6 is a flow chart of another model data processing method according to an embodiment of the present application. As shown in FIG. 6, the method may include the following steps.

Step S602, call, in response to a model execution instruction acting on an operation interface, a target execution unit to be executed currently, where the target execution unit is determined based on a predetermined execution order of any execution unit in a deep learning model, and weight data of the any execution unit is loaded into a first storage space of a first storage device.

In the technical solution provided in the above-mentioned step S602 of the present application, the model execution instruction on the operation interface can be obtained, and the target execution unit to be executed currently can be called in response to the model execution instruction acting on the operation interface.

In an implementation, the target execution unit in the deep learning model can be determined based on the predetermined execution order in the deep learning model, and the target execution unit to be executed currently can be called in response to the model execution instruction acting on the operation interface.

Step S604, execute the target execution unit, in response to an object execution instruction acting on the operation interface and based on the weight data of the target execution unit loaded into the first storage space, where weight data of each execution unit is stored in a first target storage space of at least one first target storage device in a storage device set in accordance with the predetermined execution order of each execution unit in the deep learning model, and the weight data of the target execution unit is returned to and stored in the first storage space via in turn at least one storage device included in a storage device set.

In the technical solution provided in the above-mentioned step S604 of the present application, the weight data of each execution unit can be stored, in accordance with the predetermined execution order of each execution unit in the deep learning model, into the first target storage space of at least one first target storage device in the storage device set, where the storage device set can be associated with the first storage device, and the storage performance of each of storage spaces included in the storage device set is lower than the storage performance of the first storage device. The weight data of the target execution unit can be returned to and stored in the first storage space via in turn at least one storage device included in a storage device set. The target execution unit can be executed in response to the object execution instruction acting on the operation interface and based on the weight data of the target execution unit loaded into the first storage device.

Through the above-mentioned steps S602 to S604, the target execution unit to be executed currently is called, in response to the model execution instruction acting on the operation interface, where the target execution unit is determined based on the predetermined execution order of any execution unit in the deep learning model, and the weight data of the any execution unit is loaded into the first storage space of the first storage device; and the target execution unit is executed in response to the object execution instruction acting on the operation interface and based on the weight data of the target execution unit loaded into the first storage space, where the weight data of each execution unit is stored in the first target storage space of the at least one first target storage device in the storage device set in accordance with the predetermined execution order of each execution unit, and the weight data of the target execution unit is returned to and stored in the first storage space via in turn the at least one storage device included in the storage device set, thereby achieving the technical effect of reducing the storage space occupied by data processing during the execution of the model and solving the technical problem of the large amount of storage space occupied by data processing during the execution of the model.

An embodiment of the present application further provides another model data processing method, which can be applied to a software service side (Software-as-a-Service, SaaS for short). It should be noted that the model data processing method of this embodiment can be executed by the model data processing system of the embodiment of the present application.

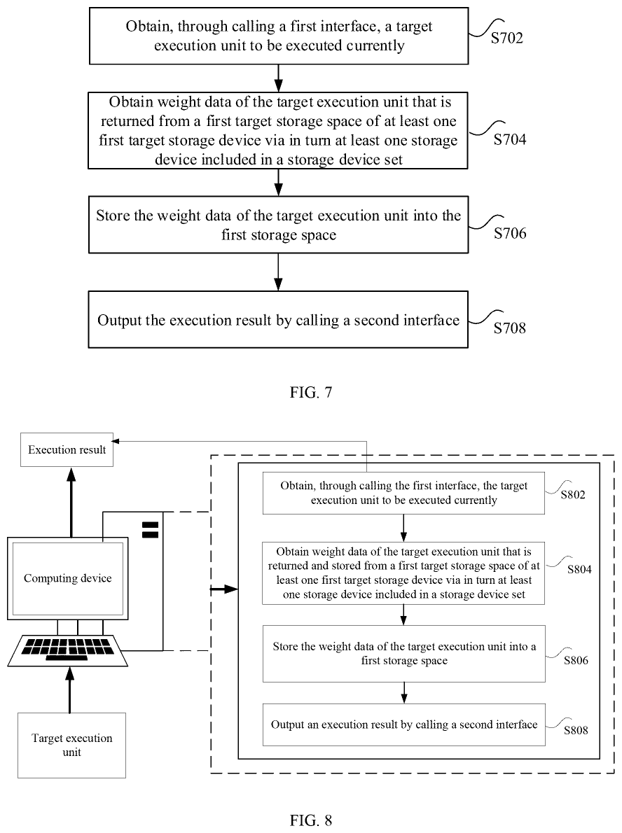

FIG. 7 is a flow chart of another model data processing method according to an embodiment of the present application. As shown in FIG. 7, the method may include the following steps.

Step S702, obtain, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device.

In the technical solution provided in the above-mentioned step S702 of the present application, the first interface may be an interface for data interaction between a server and a user end. The user end can obtain the target execution unit to be executed currently by calling the first interface. The target execution unit serves as the first parameter of the first interface to achieve the purpose of obtaining the target execution unit.

Step S704, obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order.

Step S706, store the weight data of the target execution unit into the first storage space, where the weight data of the target execution unit stored in the first storage space is used for execution of the target execution unit to obtain an execution result.

Step S708, output the execution result by calling a second interface, where the second interface includes a second parameter, and a parameter value of the second parameter is the execution result.

In the technical solution provided in the above-mentioned step S708 of the present application, the second interface may be an interface for data interaction between a server and a user end. The server can issue the execution result to a client, so that the client can output the execution result to the second interface as a parameter of the second interface, thereby achieving the purpose of issuing the execution result to the user end.

FIG. 8 is a schematic diagram of a computer device accessing a private network according to an embodiment of the present application. As shown in FIG. 8, a target execution unit to be executed currently can be obtained by calling a first interface, and a computer device specifically performs the following steps: step S802, obtain, through calling the first interface, the target execution unit to be executed currently; step S804, obtain weight data of the target execution unit that is returned from a first target storage space of at least one first target storage device via in turn at least one storage device included in a storage device set; step S806, store the weight data of the target execution unit into a first storage space; step S808, output an execution result by calling a second interface.

In an implementation, a platform can output the execution result by calling the second interface, where the second interface can be used for the purpose of issuing the execution result to a client so that the client can send the execution result.

In the embodiment of the present application, the target execution unit to be executed currently is obtained by calling the first interface, where the first interface includes the first parameter, and the parameter value of the first parameter is the target execution unit; and the target execution unit is determined based on the predetermined execution order of any execution unit included in the deep learning model, and the weight data of any execution unit is to be loaded into the first storage space of the first storage device; the weight data of the target execution unit that is returned from the first target storage space of the at least one first target storage device via in turn the at least one storage device included in the storage device set is obtained, where the storage device set includes the at least one first target storage device, and the first target storage device is configured to in advance store the weight data of each execution unit into the first target storage space in turn in accordance with the predetermined execution order; the weight data of the target execution unit is stored into the first storage space, where the weight data of the target execution unit stored in the first storage space is used for the execution of the target execution unit to obtain an execution result; the execution result is output by calling the second interface, where the second interface includes the second parameter, and the parameter value of the second parameter is the execution result, thereby achieving the technical effect of reducing the storage space occupied by data processing during the execution of the model and solving the technical problem of the large amount of storage space occupied by data processing during the execution of the model.

### Embodiment 2

As scenarios become increasingly complex, more and more deep learning models will be used. In scenarios such as multilingual machine translation, multilingual recognition, or the like, the number of deep learning models for online services can reach over 100.

At present, a general memory (memory) of a central processing unit of a single machine's standalone memory and an exclusive memory (video memory) of a graphics processing unit of a single graphics card are limited, and it is impossible to simultaneously deploy all deep learning models on the single machine or the single card. Although the memory problem can be alleviated to a certain extent by grouping and deploying some deep learning models into different clusters, this also has problems such as waste of computing resources due to load imbalance. Therefore, in a case of limited computing resources, deployment failure may still be incurred due to insufficient memory or video memory.

In the related art, deep learning model service scenarios are becoming more and more complex. As the number of models increases, resources of video memories become the bottleneck of the development of deep learning models, resulting in a waste of computing resources (such as central processing units or graphics processing units).

For example, in the multilingual translation service scenario, there are hundreds of different deep learning models. Due to the limitation of video memory, in fact, only a few deep learning models can perform inference simultaneously by a single machine, which is far less than the total number of models. The number of translation requests that can be processed simultaneously by the single machine is positively correlated with the number of deep learning models that can perform inference simultaneously by the single machine. The utilization rate of the computing resources of the central processing unit or graphics processing unit is positively correlated with the number of translation requests per unit of time within a certain range. Therefore, the limitation of the video memory may lead to the limitation of the number of models that can perform inference, which may result in the insufficient number of translation requests, so that the computing resources of the central processing unit or graphics processing unit cannot be fully utilized and waste is caused.

In order to solve the problem that a large amount of storage space is occupied by data processing during the model execution process, resulting in wasted computing resources, the present application proposes a method for saving video memory for deep learning model services, which loses some time appropriately in exchange for the reduction of video memory, thereby improving resource utilization and reducing costs.

The above-mentioned method of this embodiment is further introduced below.

The core problem of insufficient video memory resources is that the cost of video memory resources is relatively high. A graphics processing unit usually has less than 20 G of video memory, which usually costs tens of thousands of RMB. However, the cost of memory is very cheap, and the cost of the same storage device is less than 1/100 of the cost of graphics processing unit.

In computer architecture, hierarchical storage and time-space tradeoff are typically applied. That is, when the model is running, the occupancy of the video memory is mainly divided into a weight part and a part of a minimum running intermediate data storage unit (Tensor). The weight part may be the weight data of the minimum execution unit (OP) of the model, which may be a static and unchanging part, that is, the weight part does not need to change with a change of a request. The minimum execution unit of the model and the minimum running intermediate data storage unit share the video memory space, but the weight of the minimum running intermediate data storage unit may change with the change of request.

In an implementation, in the deep learning model (Transformer) with the self-attention mechanism, a weight proportion of the weight part is typically the weight part divided by the sum of the weight part and the minimum running intermediate data storage unit, which can be calculated by the following formula:

$$weight proportion = weight part / ( weight part + weight of intermediate tensor )$$

Therefore, in a case of a deep learning model is established, when a smaller sequence length (sequence_len, seq_len for short) and a smaller batch size is set, since the minimum intermediate data storage part is smaller, and the weight of the intermediate tensor is smaller, so that the weight part of the execution unit can get a larger weight proportion, for example, it may account for about 80% of the total video memory occupancy.

The present application is mainly aimed at optimizing the weight part that is static and unchanging. For this static and unchanging video memory occupancy, an optimization scheme of swapping in and out (hierarchical storage) is proposed.

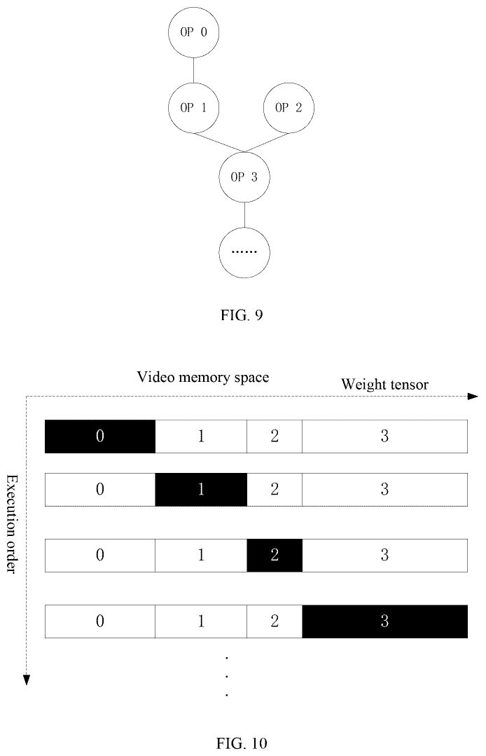

FIG. 9 is a schematic diagram of a connection of minimum execution units of a model according to an embodiment of the present application. As shown in FIG. 9, a minimum execution unit 0 (OP0) is connected to a minimum execution unit 1 (OP1), and the minimum execution unit 1 (OP1) and a minimum execution unit 2 (OP2) are respectively connected with a minimum execution unit 3 (OP3).

The model shown in FIG. 9 is taken as an example. FIG. 10 is a schematic diagram of video memory space occupation according to a related art. FIG. 10 shows the occupancy (corresponding to blocks noted with 0, 1, 2, and 3 in FIG. 10, respectively) of the weight data (weight tensor) on which the first four minimum execution units of the model relies in the video memory space, where a weight tensor on which OP0 relies is noted with 0, a weight tensor on which OP1 relies is noted with 1, a weight tensor on which OP2 relies is noted with 2, and a weight tensor on which OP3 relies is noted with 3. The black part in FIG. 10 is the tensor required by the minimum execution unit currently executed.

As shown in FIG. 9 and FIG. 10, OP0 to OP3 correspond to the four weight storage units on which they rely, which may be weight tensors. For a deep learning model, when the process of being given an input, running, and obtaining an output (inference process) begins, the weight tensors on which all the smallest execution units rely need to be loaded into the video memory space together; during inference execution, the corresponding weight tensor on which each minimum execution unit relies is used for loop execution respectively in accordance with the execution order of each minimum execution unit. The occupancy of the video memory by the weight during the model execution is the sum of the video memory space occupied by all weight tensors. Therefore, there is a technical problem in the related art that data processing during the model execution occupies a large storage space.

In this embodiment, the model shown in FIG. 9 is taken as an example, where the storage space may be divided into a plurality of levels from high to low, for example, which may be video memory space level0, memory space level1 and disk space level2, or may be video memory space level0 and memory space level1, or the like. It should be noted that the plurality of levels may be video memory space level0 and any other one or more levels, and there is no specific limitation on the number of levels here. The lower the level, the closer it is to the video memory, the higher the performance and the higher the unit cost. The number of levels may be determined based on actual scenarios, thereby achieving a purpose for balance between model performance and unit cost.

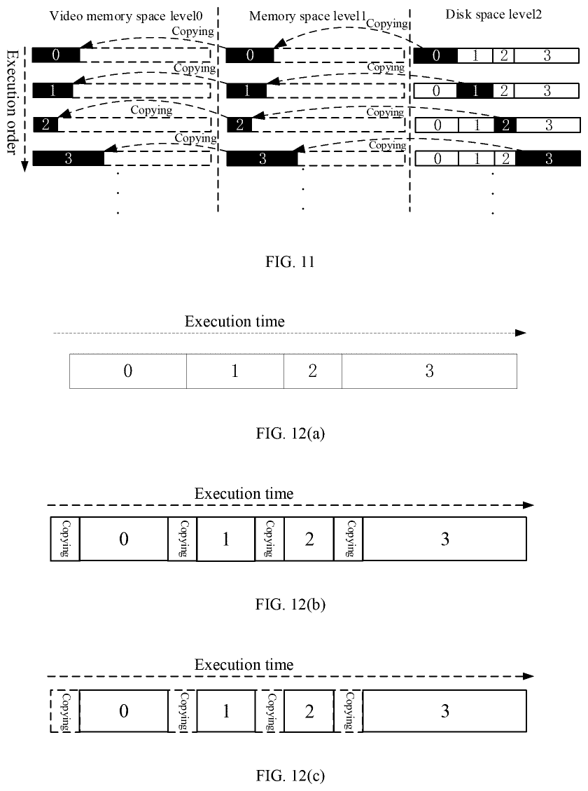

FIG. 11 is a schematic diagram of hierarchical swap-in and swap-out for weight tensor according to an embodiment of the present application. As shown in FIG. 11, when inference starts, the weight data on which all minimum execution units rely are loaded together to a high level (disk space level2) as cold storage. The cold storage may be generated offline through matching tools, or may be generated when the first inference is started online; and the cold storage corresponds to the part of disk space level2 in FIG. 11, which has low performance and low cost. During inference execution, before execution of each minimum execution unit, the weight data on which the minimum execution unit relies can be copied from the high-level space to the low-level space, and finally into the video memory space (level0).

In an implementation, after the weight data on which the minimum execution unit relies is copied to the video memory space, each minimum execution unit is executed in sequence in accordance with the execution order and executed cyclically. After the execution of each minimum execution unit is completed, the memory occupied by the weight part corresponding to the minimum execution unit can be released, or marked as invalid, or can be directly overwritten before the subsequent minimum execution unit runs.

In the related art, during the execution of the model, the occupancy of the video memory space is the sum of all weight tensors; in this embodiment, the occupancy of the video memory space during the execution of the model is the maximum value among the video memory space occupied by all weight tensors. The method merely occupies a part of the video memory space, and therefore, the video memory occupancy is much smaller than the video memory occupancy in the related art, and the greater the total weight of the model, the more obvious the effect is, thereby achieving the purpose of reducing the storage space occupied by data processing during the execution of the model.

FIG. 12(a) is a schematic diagram of an execution time according to a related art. As shown in FIG. 12(a), the total execution time is the sum of the execution time of all minimum execution units; FIG. 12(b) is a schematic diagram of an execution time according to the present application. As shown in FIG. 12(b), the time loss in the present application is mainly the time spent for copying the weight tensor from the high-level storage space to the low-level storage space. In order to reduce the impact of this extra copying on performance, this embodiment also provides a mechanism for customizing which weight tensors to be swapped in and swapped out in a hierarchical manner. Users can formulate relevant strategies according to actual needs to determine which weight tensors need to be copied, to flexibly determine the run time (RunTime, referred to as RT) of the video memory.

For example, FIG. 12(c) is a schematic diagram of an execution time of flexibly determining hierarchical storage according to the present application. As shown in FIG. 12(c), dashed blocks can represent the data storage unit whose weight can be flexibly swapped in and swapped out in a hierarchical manner. The top N units with the largest weights in the model can be marked as requiring swapping in and swapping out. The value of N can be determined through actual testing, which is related to the total video memory size of a machine and the range of allowable running time for a service.

In an embodiment of the present application, the weight tensor of each minimum execution unit in the model is stored in a hierarchical manner on storage devices with different performance and price, such as hard disk-memory of central processing unit-video memory of graphics processing unit, where the inference time is exchanged for the video memory space through appropriate strategies, to obtain better cost performance, thereby solving the technical problem of large storage space occupied by data processing during model execution and achieving the technical effect of reducing the storage space occupied by data processing during model execution.

It should be noted that, for the sake of simplicity of description, the method embodiments are all expressed as a series of action combinations, but those skilled in the art should be aware that the present application is not limited to the described order of actions, because according to the present application, certain steps can be performed in other orders or simultaneously. Secondly, those skilled in the art should also be aware that the embodiments described in the specification are all preferred embodiments, and the actions and modules involved are not necessarily required by the present application.

Through the description of the implementations above, those skilled in the art can clearly understand that the method according to the embodiments mentioned above can be implemented by means of software and a necessary general hardware platform, and of course by hardware, but in many cases the former is a better implementation. Based on this understanding, the essence, or the part that contributes to the prior art of the technical solution of the present application can be embodied in the form of a software product. The computer software product is stored in a storage medium (e.g., an ROM/RAM, a diskette, or a compact disk) and includes several instructions for causing a terminal device (which may be a cell phone, a computer, a server, a network device, or the like) to execute the methods in the respective embodiments of the present application.

### Embodiment 3

According to an embodiment of the present application, a model data processing apparatus is further provided for implementing the model data processing method shown in FIG. 5 mentioned above.

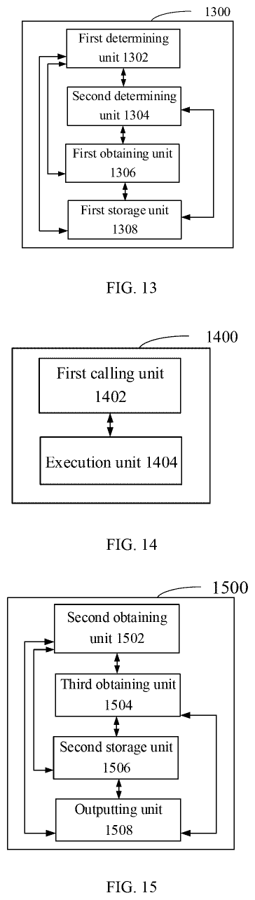

FIG. 13 is a schematic diagram of a model data processing apparatus according to an embodiment of the present application. As shown in FIG. 13, the model data processing apparatus 1300 may include: a first determining unit 1302, a second determining unit 1304, a first obtaining unit 1306, and a first storage unit 1308.

The first determining unit 1302 is configured to determine a deep learning model to be executed.

The second determining unit 1304 is configured to: determine, based on a predetermined execution order of any execution unit included in the deep learning model, a target execution unit to be executed currently, where weight data of the any execution unit is to be loaded into a first storage space of a first storage device.

The first obtaining unit 1306 is configured to: obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order.

The first storage unit 1308 is configured to: store the weight data of the target execution unit into the first storage space, where the weight data of the target execution unit stored in the first storage space is used for execution of the target execution unit.

It should be noted here that the steps respectively executed by the first determining unit 1302, the second determining unit 1304, the first obtaining unit 1306 and the first storage unit 1308 correspond to steps S502 to S508 respectively in Embodiment 1, and the instances implemented by and application scenarios of the four units are the same as the instances implemented by and application scenarios of the corresponding steps, but are not limited to the contents disclosed in the Embodiment 1. It should be noted that the units may be hardware components or software components that are stored in a memory (e.g., memory 104) and processed by one or more processors (e.g., processors 102a, 102b, . . . , 102n), and the units may also be run in the computer terminal A provided in Embodiment 1 as part of the apparatus.

According to an embodiment of the present application, a model data processing apparatus is further provided for implementing the model data processing method shown in FIG. 6 mentioned above.

FIG. 14 is a schematic diagram of another model data processing apparatus according to an embodiment of the present application. As shown in FIG. 14, the model data processing apparatus 1400 may include: a first calling unit 1402 and an execution unit 1404.

The first calling unit 1402 is configured to: call, in response to a model execution instruction acting on an operation interface, a target execution unit to be executed currently, where the target execution unit is determined based on a predetermined execution order of any execution unit included in a deep learning model, and weight data of the any execution unit is loaded into a first storage space of a first storage device.

The execution unit 1404 is configured to: execute the target execution unit, in response to an object execution instruction acting on the operation interface and based on the weight data of the target execution unit loaded into the first storage space, where weight data of each execution unit is stored in a first target storage space of at least one first target storage device in a storage device set in accordance with the predetermined execution order of each execution unit, and the weight data of the target execution unit is returned to and stored in the first storage space via in turn at least one storage device included in the storage device set.

It should be noted here that the steps respectively executed by the first calling unit 1402 and the execution unit 1404 correspond to steps S602 to S604 respectively in Embodiment 1, and the the instances implemented by and application scenarios of two units are the same as the instances implemented by and application scenarios of the corresponding steps, but are not limited to the contents disclosed in the Embodiment 1. It should be noted that the units may be hardware components or software components that are stored in a memory (e.g., memory 104) and processed by one or more processors (e.g., processors 102a, 102b, . . . , 102n), and the units may also be run in the computer terminal A provided in Embodiment 1 as part of the apparatus.

According to an embodiment of the present application, a model data processing apparatus is further provided for implementing the model data processing method shown in FIG. 7 mentioned above.

FIG. 15 is a schematic diagram of another model data processing apparatus according to an embodiment of the present application. As shown in FIG. 15, the model data processing apparatus 1500 may include: a second obtaining unit 1502, a third obtaining unit 1504, a second storage unit 1506, and an outputting unit 1508.

The second obtaining unit 1502 is configured to obtain, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device.

The third obtaining unit 1504 is configured to: obtain weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order.

The second storage unit 1506 is configured to: store the weight data of the target execution unit into the first storage space, where the weight data of the target execution unit stored in the first storage space is used for execution of the target execution unit to obtain an execution result.

The outputting unit 1508 is configured to: output the execution result by calling a second interface, where the second interface includes a second parameter, and a parameter value of the second parameter is the execution result.

It should be noted here that the steps respectively executed by the second obtaining unit 1502, the third obtaining unit 1504, the second storage unit 1506, and the outputting unit 1508 correspond to steps S702 to S708 respectively in Embodiment 1, and the instances implemented by and application scenarios of the four units are the same as the instances implemented by and application scenarios of the corresponding steps, but are not limited to the contents disclosed in the Embodiment 1. It should be noted that the units may be hardware components or software components that are stored in a memory (e.g., memory 104) and processed by one or more processors (e.g., processors 102a, 102b, . . . , 1.02n), and the units may also be run in the computer terminal A provided in Embodiment 1 as part of the apparatus.

In the model data processing apparatus of this embodiment, the storage device set is obtained, and the weight data of each execution unit is stored in the first target storage space in the storage device set in turn. The weight data in the first target storage space can be returned into the first storage space via in turn at least one storage device in the storage device set, thereby finally achieving the purpose of storing the weight data into the first storage device. Before the target execution unit is executed, the weight data corresponding to the target execution unit stored in the first storage space can be obtained, to execute the target execution unit based on the weight data, thereby achieving the technical effect of reducing the storage space occupied by data processing during the execution of the model, and solving the technical problem of large storage space occupied by data processing during the execution of the model.

### Embodiment 4

An embodiment of the present application may provide a computer terminal, which may be any computer terminal device in a computer terminal group. In an implementation of this embodiment, the computer terminal may also be replaced by a terminal device such as a mobile terminal.

In an implementation of this embodiment, the computer terminal may be located in at least one network device among a plurality of network devices in a computer network.

In this embodiment, the computer terminal can execute program codes in an application program of the following steps in a model data processing method: determining a deep learning model to be executed; determining, based on a predetermined execution order of any execution unit included in the deep learning model, a target execution unit to be executed currently, where weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit.

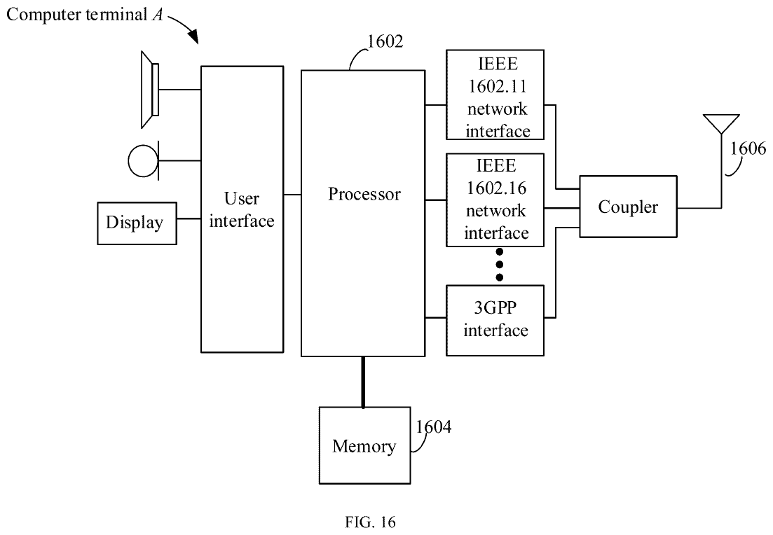

In an implementation, FIG. 16 is a structural block diagram of a computer terminal according to an embodiment of the present application. As shown in FIG. 16, the computer terminal A may include: one or more (only one is shown in the figure) processors 1602, a memory 1604, and a transmission apparatus 1606.

The memory can be used to store software programs and modules, such as the program instructions/modules corresponding to the model data processing method and apparatus in the embodiments of the present application. The processor executes various functional applications and predictions by running the software programs and modules stored in the memory, thereby realizing the model data processing method. The memory may include high-speed random access memory and may also include non-volatile memory, such as one or more magnetic storage apparatuses, flash memory, or other non-volatile solid-state memory. In some instances, the memory may further include memories remotely provided relative to a processor, and these remote memories may be connected to the computer terminal A via a network. Instances of the network include, but are not limited to, the Internet, an intranet, a local area network, a mobile communication network and combinations thereof.

The processor can call the information and application programs stored in the memory through the transmission apparatus to perform the following steps: determining a deep learning model to be executed; determining, based on a predetermined execution order of any execution unit included in the deep learning model, a target execution unit to be executed currently, where weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit.

As an example, the processor can call the information and application programs stored in the memory through the transmission apparatus to perform the following steps: calling, in response to a model execution instruction acting on an operation interface, a target execution unit to be executed currently, where the target execution unit is determined based on a predetermined execution order of any execution unit included in a deep learning model, and weight data of the any execution unit is loaded into a first storage space of a first storage device; executing the target execution unit, in response to an object execution instruction acting on the operation interface and based on the weight data of the target execution unit loaded into the first storage space, where weight data of each execution unit is stored in a first target storage space of at least one first target storage device in a storage device set in accordance with the predetermined execution order of each execution unit, and the weight data of the target execution unit is returned to and stored in the first storage space via in turn at least one storage device included in the storage device set.

As an example, the processor can call the information and application programs stored in the memory through the transmission apparatus to perform the following steps: obtaining, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit to obtain an execution result; outputting the execution result by calling a second interface, where the second interface includes a second parameter, and a parameter value of the second parameter is the execution result.

According to the embodiment of the present application, the storage device set is obtained, and the weight data of each execution unit is stored in the first target storage space in the storage device set in turn. The weight data in the first target storage space can be returned into the first storage space via in turn at least one storage device in the storage device set, thereby finally achieving the purpose of storing the weight data in the first storage device. Before the target execution unit is executed, the weight data corresponding to the target execution unit stored in the first storage space can be obtained, to execute the target execution unit based on the weight data, thereby achieving the technical effect of reducing the storage space occupied by data processing during the execution of the model, and solving the technical problem of large storage space occupied by data processing during the execution of the model.

Those skilled in the art can understand that the structure shown in FIG. 16 is merely for illustration, and the computer terminal A may also be a terminal device such as a smart phone (e.g., a tablet computer, a palm computer, a mobile Internet device (MID), a PAD, etc. FIG. 16 does not limit the structure of the computer terminal A. For example, the computer terminal A may also include more or fewer components (such as a network interface, a display apparatus, etc.) than those shown in FIG. 16, or have a configuration different from that shown in FIG. 16.

A person of ordinary skill in the art can understand that all or part of the steps in the various methods of the embodiments may be completed by instructing the hardware related to the terminal device through a program, and the program may be stored in a computer-readable storage medium, and the storage medium may include: a flash disk, a read-only memory (ROM), a random access memory (RAM), a magnetic disk or an optical disk, etc.

### Embodiment 5

An embodiment of the present application further provides a computer-readable storage medium. In an implementation of this embodiment, the computer-readable storage medium can be used to store program codes executed for the model data processing method provided in the Embodiment 1.

In an implementation of this embodiment, the computer-readable storage medium may be located in any computer terminal in a computer terminal group in computer networks, or in any mobile terminal in a mobile terminal group.

In an implementation of this embodiment, the computer-readable storage medium is configured to store program codes for performing the following steps: determining a deep learning model to be executed; determining, based on a predetermined execution order of any execution unit included in the deep learning model, a target execution unit to be executed currently, where weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit.

As an example, the computer-readable storage medium is configured to store program codes for performing the following steps: calling, in response to a model execution instruction acting on an operation interface, a target execution unit to be executed currently, where the target execution unit is determined based on a predetermined execution order of any execution unit included in a deep learning model, and weight data of the any execution unit is loaded into a first storage space of a first storage device; executing the target execution unit, in response to an object execution instruction acting on the operation interface and based on the weight data of the target execution unit loaded into the first storage space, where weight data of each execution unit is stored in a first target storage space of at least one first target storage device in a storage device set in accordance with the predetermined execution order of each execution unit, and the weight data of the target execution unit is returned to and stored in the first storage space via in turn at least one storage device included in the storage device set.

As an example, the computer-readable storage medium is configured to store program codes for performing the following steps: obtaining, through calling a first interface, a target execution unit to be executed currently, where the first interface includes a first parameter, and a parameter value of the first parameter is the target execution unit; and the target execution unit is determined based on a predetermined execution order of any execution unit included in a deep learning model, and weight data of the any execution unit is to be loaded into a first storage space of a first storage device; obtaining weight data of the target execution unit that is returned from a first target storage space of at least one first target storage device via in turn at least one storage device included in a storage device set, where the storage device set includes the at least one first target storage device, and the first target storage device is configured to in advance store weight data of each execution unit into the first target storage space in turn in accordance with the predetermined execution order; storing the weight data of the target execution unit into the first storage space, where the weight data of the target execution unit stored in the first storage space is used for execution of the target execution unit to obtain an execution result; outputting the execution result by calling a second interface, where the second interface includes a second parameter, and a parameter value of the second parameter is the execution result.

The serial numbers of the embodiments of the present application are merely for description and do not represent the advantages or disadvantages of the embodiments.

In the embodiments of the present application, the description of respective embodiments has its own emphasis. For a part that is not described in detail in a certain embodiment, please refer to the relevant description of other embodiments.

In the several embodiments provided in the present application, it should be understood that the disclosed technical contents can be embodied in other ways. Apparatus embodiments described above are merely illustrative. For example, the division of units is merely a logical function division, and there may be other division methods in actual implementations. For example, a plurality of units or components can be combined or integrated into another system, or some features can be ignored or not executed. Another point is that the mutual coupling, direct coupling or communication connection shown or discussed may be an indirect coupling or communication connection through some interfaces, units, or modules, which may be electrical or other forms.

The units described as separate components may be or may not be physically separated, and the components shown as units may be or may not be physical units, that is, they may be located in one place or may be distributed over a plurality of network units. Some or all of the units may be selected according to actual needs to achieve the purpose of the solution of this embodiment.

In addition, respective functional units in respective embodiments of the present application may be integrated into one processing unit, or respective units may exist physically separately, or two or more units may be integrated into one unit. The integrated unit can be embodied in the form of hardware or in the form of software functional unit.

If the integrated unit is embodied in the form of a software functional unit and sold or used as an independent product, it can be stored in a computer-readable storage medium. Based on this understanding, the essence, or the part that contributes to the prior art of the technical solution of the present application, or all or part of the technical solution can be embodied in the form of a software product. The computer software product is stored in a storage medium and includes several instructions for causing a computer device (which may be a personal computer, server, network device, or the like) to execute all or part of the steps of the methods of respective embodiments of the present application. The storage media include: a USB flash drive, a read-only memory (ROM), a random access memory (RAM), a mobile hard disk, a magnetic disk or an optical disk, and other media that can store program codes.

The above are merely preferred implementations of the present application. It should be pointed out that for those of ordinary skill in the art, several improvements and modifications can be made without departing from the principles of the present application. These improvements and modifications should also be regarded as the protection scope of the present application.

1. A model data processing system, comprising:
a first storage device, configured to: determine, based on a predetermined execution order of any execution unit in a deep learning model, a target execution unit to be executed currently, wherein weight data of the any execution unit is to be loaded into a first storage space of the first storage device;
at least one first target storage device, configured to: return and store weight data of the target execution unit stored in a first target storage space, into the first storage space via in turn at least one storage device in a storage device set, wherein the storage device set comprises the at least one first target storage device, and the first target storage device is configured to store in advance, in accordance with the predetermined execution order, weight data of each execution unit into the first target storage space in turn;
an execution device, configured to execute the target execution unit based on the weight data of the target execution unit stored in the first storage space.

2. The system according to claim 1, wherein each of storage devices comprised in the storage device set has storage performance lower than storage performance of the first storage device; or
the first storage space is smaller than storage spaces of the storage devices comprised in the storage device set; or
each of storage devices comprised in the storage device set has storage performance lower than storage performance of the first storage device, and the first storage space is smaller than storage spaces of the storage devices comprised in the storage device set.

3. The system according to claim 1, wherein the storage device set comprises a second target storage device in addition to the first target storage device, storage performance of the second target storage device is higher than storage performance of the first target storage device and lower than storage performance of the first storage device, wherein the first target storage device is configured to return and store the weight data of the target execution unit retrieved from the first target storage space, into the first storage space via the second target storage device.

4. The system according to claim 3, wherein the first target storage device is configured to return and store the weight data of the target execution unit retrieved from the first target storage space, into the first storage space via in turn a plurality of sorted second target storage devices, wherein the plurality of second target storage devices are sorted in ascending order of storage performance.

5. The system according to claim 1, wherein the at least one first target storage device is configured to copy the weight data of the target execution unit to the first storage device via in turn at least one storage device comprised in the storage device set.

6. The system according to claim 1, further comprising:
a processor, configured to: select at least one target identification from identifications of a plurality of storage devices associated with the first storage device, and make a storage device corresponding to the at least one target identification form the storage device set, wherein storage performance of the plurality of storage devices is lower than storage performance of the first storage device.

7. The system according to claim 1, wherein the first storage device is configured to: sort a plurality of execution units in accordance with the predetermined execution order, and determine, among the sorted plurality of execution units, an execution unit which ranks first, as the target execution unit.

8. The system according to claim 7, wherein the first storage device is configured to: determine, among the sorted plurality of execution units after the execution device executes the target execution unit based on the weight data of the target execution unit stored in the first storage space, an execution unit next to the target execution unit as the target execution unit to be executed currently, so that the first target storage device performs the step of returning and storing the weight data of the target execution unit stored in the first target storage space, into the first storage space via in turn the at least one storage device in the storage device set.

9. The system according to claim 7, wherein the deep learning model comprises an execution unit set, wherein the first target storage device is configured to: select weight data of the plurality of execution units from weight data of the execution unit set, and store weight data of each execution unit into the first target storage space in turn in accordance with the predetermined execution order of each selected execution unit in the deep learning model.

10. The system according to claim 1, wherein the first storage device is configured to:
release a storage space occupied by an executed target execution unit in the first storage device, or
mark the storage space occupied by the executed target execution unit in the first storage device with an invalid state; or
release a storage space occupied by an executed target execution unit in the first storage device, and mark the storage space occupied by the executed target execution unit in the first storage device with an invalid state.

11. A model data processing method, applied to a graphics processing unit, the method comprising:
determining a deep learning model to be executed;
determining, based on a predetermined execution order of any execution unit comprised in the deep learning model, a target execution unit to be executed currently, wherein weight data of the any execution unit is to be loaded into a first storage space of a first storage device;
obtaining weight data of the target execution unit that is returned from a first target storage space of at least one first target storage device via in turn at least one storage device comprised in a storage device set, wherein the storage device set comprises the at least one first target storage device, and the first target storage device is configured to in advance store weight data of each execution unit into the first target storage space in turn in accordance with the predetermined execution order;
storing the weight data of the target execution unit into the first storage space, wherein the weight data of the target execution unit stored in the first storage space is used for execution of the target execution unit.

12. A model data processing method, comprising:
calling, in response to a model execution instruction acting on an operation interface, a target execution unit to be executed currently, wherein the target execution unit is determined based on a predetermined execution order of any execution unit in a deep learning model, and weight data of the any execution unit is loaded into a first storage space of a first storage device;
executing the target execution unit, in response to an object execution instruction acting on the operation interface and based on weight data of the target execution unit loaded into the first storage space, wherein weight data of each execution unit is stored in a first target storage space of at least one first target storage device in a storage device set in accordance with the predetermined execution order of each execution unit, and the weight data of the target execution unit is returned to and stored in the first storage space via in turn at least one storage device comprised in the storage device set.

13. A model data processing method, applied to the model data system according to claim 1, and the method comprises:
obtaining, through calling a first interface, a target execution unit to be executed currently, wherein the first interface comprises a first parameter, and a parameter value of the first parameter is the target execution unit; and the target execution unit is determined based on a predetermined execution order of any execution unit comprised in a deep learning model, and weight data of the any execution unit is to be loaded into a first storage space of a first storage device;
obtaining weight data of the target execution unit that is returned from a first target storage space of at least one first target storage device via in turn at least one storage device comprised in a storage device set, wherein the storage device set comprises the at least one first target storage device, and the first target storage device is configured to in advance store weight data of each execution unit into the first target storage space in turn in accordance with the predetermined execution order;
storing the weight data of the target execution unit into the first storage space, wherein the weight data of the target execution unit stored in the first storage space is used for execution of the target execution unit to obtain an execution result;
outputting the execution result by calling a second interface, wherein the second interface comprises a second parameter, and a parameter value of the second parameter is the execution result.

14. A computer-readable storage medium, comprising a program stored thereon, wherein when the program is run by a processor, a device where the computer-readable storage medium is located is controlled to execute the method according to claim 11.

15. A computer-readable storage medium, comprising a program stored thereon, wherein when the program is run by a processor, a device where the computer-readable storage medium is located is controlled to execute the method according to claim 12.

16. A computer-readable storage medium, comprising a program stored thereon, wherein when the program is run by a processor, a device where the computer-readable storage medium is located is controlled to execute the method according to claim 13.

17. A computer terminal, comprising:
one or more processors, a memory, and a transmission apparatus;
wherein the memory is configured to store a program, and the processor is configured to call the program through the transmission apparatus to execute the method according to claim 11.

18. A computer terminal, comprising:
one or more processors, a memory, and a transmission apparatus;
wherein the memory is configured to store a program, and the processor is configured to call the program through the transmission apparatus to execute the method according to claim 12.

19. A computer terminal, comprising:
one or more processors, a memory, and a transmission apparatus; wherein the memory is configured to store a program, and the processor is configured to call the program through the transmission apparatus to execute the method according to claim 13.
